(19) United States
(12) Patent Application Publication
(10) Pub. No.: US 2025/0040489 A1
(43) Pub. Date: Feb. 6, 2025

(54) AUTOMATIC BALE-HANDLING MACHINE

(71) Applicant: Johannes Wissing, Stadtlohn (DE)

(72) Inventor: Johannes Wissing, Stadtlohn (DE)

(21) Appl. No.: 18/926,747

(22) Filed: Oct. 25, 2024

Related U.S. Application Data
(63) Continuation of application No. PCT/EP2023/061260, filed on Apr. 28, 2023.

(30) Foreign Application Priority Data
Apr. 28, 2022 (DE) 102022110408.7

(51) Int. Cl. A01F 29/10; A01F 29/00; A01F 29/16; B02C 23/02

(52) U.S. Cl. CPC A01F 29/10; A01F 29/005; A01F 29/16; B02C 23/02

(57) ABSTRACT

The invention relates to an automatic bale-handling machine for handling material bales, the materials that have been pressed to form bales being intended for comminution. The automatic bale-handling machine comprises a loading device which is designed to supply a bale to a comminution device, the loading device comprising a supply unit, and the supply unit being designed to transfer the bale from a first level into a second level which is located above the first level. According to the invention, the supply unit is designed as a lifting unit in such a way that the lifting unit lifts a bale from a supporting face within an action space.

### BACKGROUND

The invention relates to an automatic bale-handling machine for handling materials of all kinds which are pressed into bales and for which comminution or separation is provided, according to the features in the preamble of claim 1 and a method for handling such bales according to claim 22.

As part of the recycling process, for example, waste materials, in particular from paper, cardboard, plastics or the like, hereinafter collectively referred to as materials, are collected, comminuted if necessary and pressed into round or square bales in order to be able to transport them in reduced volume as material bales and store them in a space-saving manner. Or, for example, rejects as a product of faulty production, which are still unused, regularly uncomminuted but faulty, such as flowing materials with faulty printing or the like, are pressed into bales. In the course of recycling, the bales, which can weigh up to 1000 kg or more, are broken up again using shredders, bale breakers or similar, hereinafter referred to as comminuting equipment, wherein the materials themselves can be comminuted or separated. Feeding a comminution device with compressed bales can be important for downstream processing operations, for example to ensure continuous and homogeneous material availability.

U.S. Pat. No. 9,163,191 B2 discloses a non-generic loading device with several conveyor belts arranged one behind the other in the process sequence, which supply compressed bales consisting of plant material to a comminution device.

However, it is common practice, particularly in the processing of waste materials, that the supply openings on the powerful comminution devices are regularly arranged above the comminuting tools, such as the drum of a shredder fitted with cutting tools or the like, and therefore a flat supply, as known from U.S. Pat. No. 9,163,191 B2, is not possible. For this reason, the previously known loading devices have a supply unit which is designed in the form of a ramp-like conveyor, wherein the ramp incline regularly does not exceed 30° in order to prevent the bales from rolling down. The low incline means that the known loading devices are very space-intensive due to the necessarily long loading ramps.

As is known, the bales are fed or transferred to the loading device by means of an industrial truck, for example a forklift truck, which picks up the bales and transports them from a storage location to the loading device while maintaining short cycle times. It is regularly necessary to transport several bales at the same time, more specifically stacked on top of each other, in order to maximize the utilization of the comminution devices. Transporting and stacking several bales is risky as it restricts the visibility of the driver of the industrial truck and the stacked bales can easily fall down. Furthermore, loading machines are preferably operated in a labor-intensive multiple-shift operation, which is conducive to high capacity utilization.

The loading devices known from practice therefore share the problem that they take up a lot of installation space and can only be operated economically to a limited extent. In order to increase economic efficiency, additional personnel input is used in practice, which sometimes exposes personnel to considerable safety risks.

### BRIEF SUMMARY OF THE INVENTION

The object of the present invention is to improve what is known, in particular with regard to the aforementioned problems. The economic efficiency is to be increased in the sense of a high process reliability of the processing of the pressed materials. Furthermore, the risk of accidents for the operating personnel is to be minimized.

The object is achieved by an automatic bale-handling machine according to the features of claim 1 and by a method according to the features of claim 22. Features of the invention are discussed below, wherein further inventive embodiments of the invention are described, inter alia, in the dependent claims. These design features can be realized in conjunction with the invention or can also be inventive autonomously, independently of the invention, and they can be realized either individually and independently of one another or also in any combination, including the realization of all the features mentioned, unless a combination is expressly or technically necessarily excluded.

The invention proposes an automatic bale-handling machine for handling compressed bales which are to be fed to a comminution device in preparation for further subsequent processing steps. The present proposal is based fundamentally on the consideration of mechanical and preferably largely automated bale handling.

According to the proposal, the automatic bale-handling machine has a loading device with a supply unit, wherein the supply unit is designed as a lifting unit. Bales can be handled by the lifting unit within a space referred to as the action space of the lifting unit, in particular by lifting the bales onto or off a supporting face forming a first level. In the simplest case, a hall floor or the like, on which the comminution devices are also arranged, forms the supporting face, wherein the lifting unit can only lift or lift off a bale within the action space, for example due to design features of the lifting unit or due to structural devices in the working environment of the lifting unit which limit the action space. The action space of the proposed lifting unit is large, wherein the installation space required for it is comparatively small compared to the known loading ramps. The design of one or more action spaces or the coordination of several action spaces relate to essential considerations of the present invention. The supply unit designed as a lifting unit thus lifts a bale from the supporting face to a second level arranged above the first, so that the bale can be fed to a comminution device.

Lifting devices such as cable-crane-like systems, hydraulically operated booms or the like can be provided as lifting units, which substantially hold a bale, for example by means of bale tongs, bale grippers, bale forks, bale troughs or the like, lift it and supply it to a comminution device. Bale tongs, bale grippers and bale forks are widely known in practice and are particularly suitable. A bale trough can be advantageous if materials loosened from a bale are to be collected and lifted and fed with a bale, preferably in the case of bales of inferior pressing quality or very small or particulate materials, particularly when handling waste materials.

With the proposed lifting unit, a ramp-like design can be dispensed with, so that a significantly smaller installation space is required, which is economically advantageous. In contrast to the known ramp-like supply unit, the proposed lifting unit enables controlled supply of a bale into the supply opening of a comminution device, so that, firstly, the lifting height which must be overcome in order to be able to supply a bale to a comminution device can be reduced, in particular due to a lower overall height of a feed hopper of the comminution device. Secondly, controlled supply reduces the probability of bales getting stuck in the hopper, which in practice regularly has to be remedied by risky personnel intervention, so that, for example, process reliability can be increased and personnel costs reduced in an economically advantageous manner in accordance with the proposal.

The invention is based on the idea of proposing an automatic bale-handling machine as a buffer store in order to reduce the personnel required for the operation of a processing plant for materials, in particular waste materials, and at the same time to increase work safety. According to the proposal, the action space of the lifting unit is essential in that all the bales in the action space can be temporarily stored as a buffer store before they are fed to a comminution device by means of the lifting unit. The buffer store makes it possible, for example, to hold or temporarily store a certain quantity of bales for a comminution device to bridge a period of time, so that continuous loading by means of an industrial truck is not necessary and personnel can be saved. The size of the action space is positively correlated with the time span that can be bridged.

Furthermore, the proposed automatic bale-handling machine increases the work safety of the operating personnel. Firstly, the risk of bales weighing up to 1000 kg rolling off a ramp and injuring personnel is eliminated. Secondly, the transport safety of the bales is increased, as it is not necessary to transport several bales stacked on top of each other, which restrict the view of the driver of an industrial truck, from a storage location to a loading device. Instead, the capacity of the proposed action space can be expanded accordingly in order to be able to provide a bale quantity required for continuous loading of a comminution device and, also, to make obsolete a simultaneous transportation of several bales by means of an industrial truck to provide the required bale quantity.

In a particularly advantageous embodiment, the loading device can have a conveyor unit with a supporting face provided for receiving the bale. The supporting face can be formed, for example, by a chain conveyor, roller conveyor, conveyor belt or the like, on which bales can be picked up or carried in one or more layers. The conveyor unit creates a conveyor section, which in turn creates an action space of the conveyor unit and which opens into the action space of the lifting unit, so that a bale can be conveyed on the conveyor unit in the direction of and up to the lifting unit. Alternatively, it may be sufficient for the conveyor section to end at the action space of the lifting unit, in such a way that a bale conveyed to the lifting unit can be picked up and lifted by the lifting unit, even though the conveyor section ends outside the action space of the lifting unit. Economically advantageously, the buffer store is enlarged by the conveyor unit without requiring an increase in the action space of the lifting unit. Instead, the action space of the lifting unit could be reduced or a smaller action space of the lifting unit is sufficient to be able to hold a corresponding quantity of bales. Advantageously, the intake capacity of the conveyor unit is structurally adapted to a period of time to be bridged, for example by extending the conveyor unit or by the stacking height of the bales on top of each other, so that the intake capacity of the conveyor unit can be aligned with a bale quantity that a comminution device can process at night, for example, so that labor-intensive loading during night shifts is not necessary.

A combination of a lifting unit and conveyor unit is particularly suitable for retrofitting existing systems, wherein the design of the lifting unit and the conveyor unit and thus the design of the respective action spaces must be aligned in particular with the given structural limitations. By adapting the action space of the lifting unit, by adapting the action space of the conveyor unit and/or by adapting the intake capacity of the conveyor unit, economically advantageous individual solutions for improved loading of a comminution device can be created.

In one embodiment, it may be provided that the lifting unit has a bale holding element and that the lifting unit and/or the bale holding element are pivotable, in particular if the lifting unit is arranged locally in the space between a conveyor unit and a comminution device. In particular, a movability aligned about a substantially horizontal pivot axis can be provided so that a bale deposited in front of the lifting unit or a bale located on the conveyor unit can be gripped, lifted over the lifting unit and fed from above to a supply opening of a comminution device, wherein the lifting and supply can preferably take place economically advantageously by the pivoting movement alone.

It is particularly advantageous if several conveyor units are arranged next to each other. Firstly, the storage capacity of the intermediate storage unit can be increased accordingly. Also, bales with different characteristics, for example with regard to the type of material, weight, degree of contamination, moisture or the like, can be pre-sorted for intermediate storage in order to maximize the economically advantageous quantity of a largely homogeneous, comminuted material that can be produced.

In one embodiment, it can be provided that the lifting unit is designed to be movable, for example to increase the operating space or to load several comminution devices or if the lifting unit is arranged locally between a conveyor unit and several comminution devices, between several conveyor units and a comminution device or between several conveyor units and several comminution devices, so that the utilization of the lifting unit can be increased in an economically advantageous manner and at the same time the investment costs for several conveyor units or comminution devices can be reduced. The movability can preferably be achieved by mounting the lifting unit on rollers, wheels or the like.

In an advantageous embodiment, the automatic bale-handling machine can have a feeding station with a feeding part in the form of a feeding platform, which is to be approached by a driver of an industrial truck and on which a bale is to be placed in order to supply it to the conveyor unit and thus transfer it to the buffer store. For this purpose, the feeding platform may, for example, have roller conveyors or the like. Advantageously, the feeding station can also have a baffle wall, which is used to align several bales stacked on top of each other, in particular by means of an industrial truck, in order to ensure the most stable possible storage on the supporting face.

In a particularly advantageous embodiment, a control device can be provided to automate the automatic bale-handling machine as far as possible, wherein the automation can, for example, relate to supplying the bales into a comminution device in response to a request signal. The automated supply can economically increase the utilization of a comminution device by supplying a bale to the comminution device by means of a lifting unit to avoid empty runs as soon as the comminution of a previously supplied bale has progressed accordingly and a new supply is possible, so that a request signal is triggered. A request signal can be generated step by step as soon as a certain threshold value is reached or exceeded. Advantageously, the threshold value is defined by features of the comminution device, for example by the load capacity of the comminution device, so that damage to the comminution device can be prevented and/or the most economical operation of the comminution device can be realized. It may be possible to generate a request signal after a certain period of time has elapsed. At the same time, this type of control is advantageous in order to avoid peak loads on the comminution device and instead improve a largely homogeneous load in terms of a long service life and energy savings. Automation is also advantageous in order to be able to operate the automatic bale-handling machine largely without personnel, thus reducing the risk of accidents.

The aforementioned advantages can be further enhanced if the control device controls other components of the automatic bale-handling machine. It may preferably be provided that the control device connects the supply unit to the conveyor unit in a signal-transmitting manner, so that bales can be automatically conveyed to the lifting unit and bales can be fed to a comminution device, wherein conveying of a bale may be provided in particular when there are no or only a few bales left in the action space of the lifting unit. Advantageously, the control device can contribute to the optimized coordination of action spaces in a space-saving manner by means of a controlled loading device.

For example, information regarding the characteristics of waste materials is of great importance for economical recycling, for example the origin and type of waste materials, the degree of contamination, the weight, the moisture content or the like. Therefore, in one embodiment, a detection device can be provided which has a reading element in order to be able to read information which is stored on storage media arranged on the bale, for example an RFID transponder. In this way, it is possible to trace the composition of a batch of comminuted materials at any time, even if several bales are comminuted (one after the other) and the comminuted materials form a common mixture or batch.

The detected information can be used, for example, to sort the temporarily stored bales on the supporting face or on the supporting face of the conveyor unit depending on their characteristics, especially if several conveyor units are arranged. In this embodiment, the detection device can be advantageously arranged at the feeding station in order to detect a loaded bale directly and assign it accordingly. In terms of comprehensive space management, material flows can be stored in a traceable manner on the basis of the recording device and thus made traceable. It may also be provided that the lifting unit has a detection device, more specifically preferably if several comminution devices are arranged downstream of the lifting unit, for example in order to supply bales having certain characteristics to the same comminution device. This is conducive to homogeneous process conditions. Also, this promotes the production of a largely homogeneous, comminuted or separated material.

For an economically advantageous utilization of a comminution device, a monitoring device can be provided in one embodiment, which serves to determine a bale fill level in a comminution device. If it is detected that the comminution device has free capacity to accommodate a further bale, a request signal can be generated so that the control device controls the conveyor unit or the lifting unit accordingly to load the comminution device with a further bale.

To detect the fill level, the monitoring device can have a camera, for example, and the evaluation can be software-supported. In one embodiment, lasers, ultrasound or the like can be used to determine the fill level and generate a request signal based on this with software support. In particular, work data of the comminution device, for example an effective torque, an instantaneous drive power or the like, can be an indication of a quantity of material that is being processed in the comminution device at a particular time. It can therefore be particularly advantageous for the monitoring device to have a coupling element in order to be able to detect or receive such work data and, if necessary, to derive a request signal from it for controlling the loading device.

The materials pressed into bales are regularly bound using wire, plastics fibers, a film, a net or the like. In order to keep the materials as pure as possible and to avoid unnecessary strain on the comminuting tools, it is advantageous to remove a binding device from the bale and preferably separate them from the materials before the bale is fed to a comminution device. Since manual separation poses a high risk of accidents for the personnel due to the high pretension of the binding device, a binding device loosener can advantageously be provided, which loosens the holding device out of reach of the personnel before a compressed bale is fed to a comminution device, and which separates the holding device from the bale material if necessary. Advantageously, the binding device loosener can be arranged adjacent to, i.e., in the action space of the lifting unit, so that, for example, a bale that has been lifted by the lifting unit can be loosened and then supplied in a controlled manner to a supply opening of a comminution device. In this sense, the binding device loosener can advantageously be arranged in a vertical extension substantially above the supply opening, so that any material falling during loosening falls into the supply opening due to gravity.

Due in particular to the high investment costs for a binding device loosener, it can be economically advantageous for a binding device loosener to be arranged in such a way that bales are loosened before lifting and the loosened materials are transferred to a bale trough of the lifting unit, wherein the lifting unit is advantageously movable and arranged on a traverse and which is preferably provided for loading several comminution devices. By means of the bale trough, the loosened materials can be fed in a metered manner while maintaining optimum utilization of the comminution devices.

In one embodiment, a metering device with a conveyor part can be provided and is intended to initially pick up a loosened bale and to be able to supply the materials to a comminution device in a metered manner, for example in such a way that individual pressing layers are fed, which are formed by a pressing piston stroke when the materials are pressed.

In a particularly advantageous embodiment, the lifting unit can be arranged on a traverse, wherein the traverse is designed as a portal or bridge element. To increase the operating space of the lifting unit, the traverse can be designed to be movable. This design is advantageous, for example, in order to achieve a maximum degree of automation, as the lifting unit can act as a supply unit and as a stacking device. For example, after a first bale has been deposited in the action space of the lifting unit, for example by means of an industrial truck, a second bale, also deposited by means of an industrial truck, can be lifted by the lifting unit and deposited on the first bale, which can contribute to improved stability of a bale stack. In response to a request signal, the lifting unit can advantageously supply a bale to a comminution device. In conjunction with an advantageous detection device, the lifting unit can individually detect, lift and supply a bale. A high utilization of the lifting unit can be promoted in an economically advantageous manner, wherein the utilization of a comminution device can also be increased as a result.

Advantageously, the traverse can span the conveyor unit and be designed to move longitudinally axially to the conveyor section of the conveyor unit. For improved stacking quality, for example, the bales placed on the feeding station by an industrial truck can be supplied to the conveyor unit by means of a lifting unit and stacked optimally on the supporting face. In response to a request signal, the lifting unit can lift a bale from the supporting face and supply it to a comminution device. As before, a detection device for individual bale handling can be economically advantageous for increasing the utilization of the lifting unit or the comminution device. Conveying a bale can speed up handling, as the lifting unit does not have to travel all the way to a bale's resting place on the supporting face, but the bale is conveyed towards the lifting unit, so that the design of the action spaces can be coordinated with each other.

If it is intended to span several conveyor units, the lifting unit can be moved on the traverse in the spanning direction, i.e., substantially transverse to the alignment of a conveyor unit.

In the interests of increased work safety, in particular in the case of multi-layer stacking of the bales on the supporting face, a safety element can be provided, for example in the form of a side boundary, which stabilizes the horizontal bales or the bales stacked on top of each other on the supporting face so that they cannot fall from it. Preferably, safety elements can be arranged on both sides of the conveyor unit substantially along the conveyor section up to the mouth of the conveyor section in the action space of the lifting unit. Furthermore, safety elements can be provided which limit the accessibility of the loading device to persons, for example in the form of access barriers or the like, or such safety elements, for example in the form of light barriers or the like, which force the automatic bale-handling machine to stop operating as soon as persons enter certain risk areas, in particular the action space of the lifting unit.

In particular for a more flexible application of the automatic bale-handling machine, it can be provided that the automatic bale-handling machine has a bale lock with a feeding platform, wherein the feeding platform is preferably arranged adjacent to the lifting unit, i.e., in its action space, so that the lifting unit can, if necessary, transfer a bale, which has been placed on the feeding platform by means of an industrial truck and is to be fed into the processing in the sense of a special bale treatment, into a comminution device. An infeed can be provided in order to be able to produce a defined material mixture, for example.

In conjunction with special bale handling, the detection device can be particularly advantageous in order to be able to identify certain bales on one of several conveyor units and handle them accordingly.

Advantageously, it can be provided that the supporting face is designed as a sliding or push floor, for example in the form of a truck trailer with a sliding floor in the sense of a mobile conveyor unit. Preferably, the truck trailer can be connected to the lifting unit in a signal-transmitting manner, so that the sliding floor can be activated when a request signal is generated, for example in the case of a free capacity of a comminution device, or as soon as the lifting unit has removed a bale from the truck trailer. In particular, unmanned operation is economically advantageous and reduces the risk of accidents.

The invention also proposes a method for handling materials pressed into bales and intended for comminution. According to the proposal, one or more bales are temporarily stored in the action space of the lifting unit in the sense of a buffer store, in particular in order to be able to load a comminution device without personnel for a period of time, for example overnight or on public holidays. By means of a lifting unit, the bale is then lifted from a first level, namely the level of the supporting face, up to a second level, arranged above the first, and supplied to a comminution device, wherein the supply is controlled in that a bale is supplied by means of a lifting unit as soon as the comminution of a previously supplied bale has progressed accordingly and a new supply is possible in order to increase the utilization of the comminution device. Lastly, the bale or the materials pressed into bales is/are comminuted.

In one embodiment, the bale may first be transported from a storage location to the action space by means of an industrial truck.

In a further embodiment of the method, it may be provided that a bale is first fed onto a conveyor unit and conveyed to a lifting unit until the bale reaches the action space of the lifting unit so that it can lift the bale and supply it to a comminution device. Instead of conveying, a movability of a lifting unit may be provided, substantially along the length of the conveyor section, so that the action space is increased. The possibility of conveying a bale by means of a conveyor unit firstly increases the buffer storage capacity and secondly creates the possibility of optimizing the loading by controlling a conveyance to the supply depending on the utilization of the comminution device.

Advantageously, a loosening of the bale can be provided, for example after the bale has been lifted and before it is supplied to a comminution device, in order to be able to supply the materials to the comminution device more easily and to be able to separately remove a binding device which holds the bale together in a compressed state and which could possibly contaminate the materials unnecessarily, in particular in the sense of purity of type.

In one embodiment, it may be provided that a binding device loosener is arranged in such a way that bales are loosened before lifting and the loosened materials are transferred to a bale trough of the lifting unit, wherein the lifting unit advantageously loads several comminution devices. By means of the bale trough, the loosened materials can be optimally supplied to the advantage of a high utilization of the comminution devices.

Advantageously, the loosened bale can be supplied to a comminution device in a metered manner in such a way that materials are continuously supplied into a comminution device, wherein as large a quantity of material as possible is comminuted per unit of time and at the same time as little drive energy as possible is consumed by the comminution device.

A detection system may be provided to detect the bales, in particular features such as the type of material, the weight, the degree of soiling, the moisture content or the like, preferably after a bale has been lifted or lowered.

The explained features of the automatic bale-handling machine, in particular the portal or bridge solution described, each have an independent inventive significance. They can be used together in any combination or individually and independently of each other.

An exemplary embodiment of the invention is explained in greater detail below with reference to a schematic diagram, wherein individual features or a combination of features of the illustrated exemplary embodiment can also be realized independently of the rest of the form of the exemplary embodiment in a method according to the proposal. In said diagram

### BRIEF DESCRIPTION OF THE DRAWINGS

FIG. 1 shows a schematic representation of an exemplary method sequence.

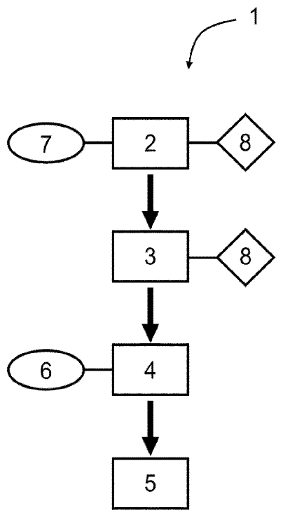

### DETAILED DESCRIPTION

In the present exemplary embodiment of a method 1, several bales are temporarily stored 2 on a supporting face. To increase the buffer capacity, the supporting face is enlarged so that it is partially arranged outside the action space of the lifting unit. Using a conveyor unit, the bales are conveyed along a conveyor section of the supporting face in the direction of the lifting unit 7 until the bales reach the action space of the lifting unit.

A bale located in the action space of the lifting unit is lifted from the supporting face 3 and supplied 4 to a comminution device. In the comminution device, the bale is comminuted as required 5 so that the comminuted materials can be supplied to further processing steps. In order to determine the progress of the comminution process, the current drive power of the comminution device is determined. As soon as a certain threshold value is reached, fallen below or exceeded, a request signal is generated. The intention is to align the threshold value with the load capacity of the comminution device, with the result that downtimes can be maximized in an economically advantageous manner. For largely automated operation, the request signal is processed by a control device that controls the bale supply 6 in such a way that a bale is supplied 4 as soon as a request signal is detected.

Furthermore, the bales in the present exemplary embodiment each have a storage medium. Information about the type of material and the degree of soiling of the materials is stored. The stored information is recorded by means of a reading element 8, specifically while the bales are temporarily or buffer-stored 2 on the supporting face of the conveyor unit and/or while the lifting unit lifts the respective bale from the supporting face 3. Against the background that several bales are regularly comminuted one after the other 5 and the comminuted substances form a common mixture or batch, the recording of information 8 serves, among other things, to ensure the traceability of the comminuted substances, so that conclusions can be drawn at any time, for example with regard to the composition of a batch of comminuted materials.

In a particularly advantageous exemplary embodiment (not shown), both the bale conveyor 7 and the bale lift 3 are also controlled. This integrated control of coordinated action spaces means that the automatic bale-handling machine can firstly be operated particularly economically and, secondly, safety risks for the personnel are minimized.

### REFERENCE SIGNS

1 method
2 buffer storage
3 lifting
4 supply
5 comminution
6 control
7 conveyance
8 recording

1. An automatic bale-handling machine for handling bales of material, wherein the materials pressed into bales are intended for comminution,
having a loading device which is designed to supply a bale to a comminution device, wherein the loading device has a supply unit and the supply unit is designed in such a way to transfer the bale from a first level into a second level lying thereabove,
characterized in that
the supply unit is designed as a lifting unit in such a way that the lifting unit lifts a bale within an action space of the lifting unit from a supporting face carrying the bale.

2. The automatic bale-handling machine as claimed in claim 1,
characterized in that
the loading device has a conveyor unit with a supporting face provided for receiving the bale,
wherein the conveyor unit creates a conveyor section along which the bale can be conveyed in the direction of the lifting unit and which opens out into the action space of the lifting unit or ends at the action space of the lifting unit.

3. The automatic bale-handling machine as claimed in claim 1,
characterized in that
the lifting unit has a bale-holding element,
and in that the lifting unit and/or the bale-holding element are designed to be pivotable.

4. The automatic bale-handling machine as claimed in claim 2,
characterized by
a plurality of conveyor units, wherein the conveyor units are arranged side by side.

5. The automatic bale-handling machine as claimed in 1,
characterized in that
the lifting unit is movable.

6. The automatic bale-handling machine as claimed in claim 2,
characterized by
a feeding station with a feeding part which is intended to supply a bale to the conveyor unit.

7. The automatic bale-handling machine as claimed in claim 1,
characterized by
a control device for controlling the loading device in response to a request signal, wherein the comminution device and/or an elapsed time period triggers the request signal.

8. The automatic bale-handling machine as claimed in claim 7,
characterized in that
the control device connects the supply unit to the conveyor unit in a signal-transmitting manner.

9. The automatic bale-handling machine as claimed in claim 7,
characterized by
a detection device with a reading element, wherein the detection device is connected to the control device in a signal-transmitting manner and is intended to detect features of a bale.

10. The automatic bale-handling machine as claimed in claim 9,
characterized in that
the lifting unit and/or the feeding station comprises the detection device.

11. The automatic bale-handling machine as claimed in one of claim 7,
characterized by
a monitoring device which is connected to the control device in a signal-transmitting manner and is intended to monitor the fill level of a comminution device.

12. The automatic bale-handling machine as claimed in claim 11,
characterized in that
the monitoring device comprises a camera.

13. The automatic bale-handling machine as claimed in claim 11,
characterized in that
the monitoring device has a coupling element which is intended to detect and/or receive work data of the drive of a comminution device.

14. The automatic bale-handling machine as claimed in claim 1,
characterized by
a binding device loosener which is arranged adjacent to the lifting unit and is intended to loosen a binding device of a bale.

15. The automatic bale-handling machine as claimed in claim 14,
characterized by
a metering device with a conveyor part, wherein the metering device is intended to receive a loosened bale.

16. The automatic bale-handling machine as claimed in claim 1,
characterized in that
the lifting unit is arranged on a traverse,
wherein the traverse is designed as a portal or bridge element.

17. The automatic bale-handling machine as claimed in claim 16,
characterized in that
the traverse is movable.

18. The automatic bale-handling machine as claimed in claim 16,
characterized in that
the traverse spans the conveyor unit and is movable longitudinally axially to the conveyor section.

19. The automatic bale-handling machine as claimed in claim 2,
characterized in that
a safety element is arranged on the conveyor unit in such a way that the safety element stabilizes a bale located on the supporting face.

20. The automatic bale-handling machine as claimed in claim 2,
characterized by
a bale lock with a feeding platform which is arranged adjacent to the lifting unit and is intended to receive a bale as an alternative to the conveyor unit.

21. The automatic bale-handling machine as claimed in claim 1,
characterized in that
the bale holding element is a pair of bale tongs, a bale gripper, a bale fork or a bale trough.

22. A method (1) for handling bales of material,
wherein the materials pressed into bales are intended for comminution, according to the following steps:
a) buffer-storing (2) a bale resting on a supporting face in the action space of a lifting unit,
b) lifting (3) the bale from the level of the supporting face by the lifting unit,
c) supplying (4) the bale to a comminution device, and
d) comminuting (5) the bale in the comminution device,
wherein step c) is controlled (6) by supplying a bale as soon as the comminution (5) of a previously supplied bale has progressed accordingly and a new supply (4) is possible in order to increase the utilization of the comminution device.

23. The method as claimed in claim 22,
characterized in that
the bale is fed onto a conveyor unit in the method sequence before step a),
and in that the bale is conveyed (7) by the conveyor unit in the direction of the lifting unit.

24. The method as claimed in claim 22,
characterized in that
the bale is loosened in the method sequence before or after step b).

25. The method as claimed in claim 24,
characterized in that
the loosened bale is supplied in a metered manner to a comminution device in step c).

26. The method as claimed in claim 22,
characterized in that
in the method sequence bale features are detected by a detection device (8) before step c).
